(19) United States
(12) Patent Application Publication
(10) Pub. No.: US 2017/0252976 A1
(43) Pub. Date: Sep. 7, 2017

(54) Apparatus, system, and method for 4-dimensional molecular printing

(71) Applicants: Adam B. Braunschweig, New York, NY (US); Yiwen JI, Coral Gables, FL (US); Xiaoming LIU, Coral Gables, FL (US); Yeting ZHENG, Coral Gables, FL (US)

(72) Inventors: Adam B. Braunschweig, New York, NY (US); Yiwen JI, Coral Gables, FL (US); Xiaoming LIU, Coral Gables, FL (US); Yeting ZHENG, Coral Gables, FL (US)

(73) Assignee: University of Miami, Miami, FL (US)

(21) Appl. No.: 15/447,067

(22) Filed: Mar. 1, 2017

Related U.S. Application Data
(60) Provisional application No. 62/302,318, filed on Mar. 2, 2016.

(51) Int. Cl. B29C 67/00; B33Y 30/00; B33Y 50/02; B33Y 10/00

(52) U.S. Cl. CPC B29C 67/0085; B29C 67/007; B33Y 10/00; B33Y 30/00; B33Y 50/02

(57) ABSTRACT

A method and apparatus for 4-dimensional printing are disclosed. The apparatus includes a polymer pen array translatable in three axes, a light source for illuminating the polymer pen array, a reactive surface disposed opposite the polymer pen array, and a flow-through microfluidic cell having a reactive chamber in fluid communication with influx and outflux conduits. Solutions containing reagents are introduced into the reactive chamber, the polymer pen array is inserted into the reactive chamber, and is then illuminated with the light source so as to initiate polymerization between the reagents and the reactive surface.

### CROSS-REFERENCE TO RELATED APPLICATIONS

This application claims priority to U.S. Provisional Patent Application Ser. No. 62/302,318, filed on Mar. 2, 2016 and entitled “4-DIMENSIONAL PRINTER”, the contents of which are incorporated herein in their entirety by reference.

### STATEMENT REGARDING FEDERALLY SPONSORED RESEARCH OR DEVELOPMENT

This invention was made with government support under grant number 15RT0675 awarded by the Department of Defense (MUM), under grant numbers DBI-1353823 and DBI-1152169 awarded by the National Science Foundation. The government has certain rights in the invention.

### BACKGROUND

Microarray fabrication and 3-dimensional printing is a rapidly growing field. Current techniques for creating ultradense nanopatterns of molecules include, but are not limited to, photolithography, pin printing, dip-pen lithography (DPN), polymer pen lithography (PPL) and micro-contact printing (μCP). However, such techniques have limitations. For example, in photolithography, the harsh experiment conditions can limit biological applications. Furthermore, while PPL and μCP can be bio-compatible, the immobilization of multiple inks during printing with such techniques remains a challenge.

Systems with sophisticated optoelectronic, biological, and material properties may be produced by developing 4D patterning tools that can control the position (x,y), height (z), and monomer composition of each feature in a brush polymer array with sub-1 micrometer precision. Achieving such regulation over spatial resolution and chemical composition in a single printing platform requires compatibility with delicate organic and biologically active materials that do not survive the intense irradiation involved in conventional nanopatterning techniques, such as e-beam, ion-beam, or extreme UV lithography. Several recently developed strategies print organic materials with sub-micrometer dimensions, and, of these, massively parallel scanning probe lithography (SPL) has emerged as an attractive approach because it can print over large (>1 cm²) areas, is compatible with a wide range of organic materials, can create arbitrary patterns without requiring the prefabrication of a photomask, and can print features as small as 80 nm in diameter. Massively parallel SPL has been shown to be able use arrays composed of up to 10⁷ elastomeric pyramids that are mounted onto the piezoelectric actuators of an atomic force microscope. Patterns that involve the covalent immobilization of soft materials can be made by either the direct deposition of a reactive ink, or using tips to localize force or light to induce a chemical reaction between the appropriately functionalized surface and reactive groups in the molecules. Recent advances, such as apertureless, beam-pen, and fluid phase lithographies have made 4D printing with SPL a possibility by providing a means to localize light using pen arrays and performing these reactions in fluid, respectively. In addition, using the mold in which the pens are made as an ink reservoir provides a route towards printing multiple inks onto a surface with massively parallel arrays, but, in this method, each pen can only print inks of a single composition. Thus, as new techniques arise for creating nanopatterns, SPL may be increasingly considered as a viable approach towards desktop micro- and nanomanufacturing, particularly for patterning soft materials for which conventional nanolithographies are not well-suited. The next major challenge that remains for massively parallel printing approaches is the development of strategies for introducing multiple inks to the surface, and controlling the height at each position. These goals can be achieved by the combination of instrumentation development with brush-polymer chemistry.

The use of beam pen arrays—where the elastomeric tips within a massively parallel pen array are coated with a layer metal that possesses an aperture at the apex to allow the passage of light—to create 3D fluorescent polymer nanoarrays via a thiol-acrylate photochemical grafted-from polymerization, has recently been reported (S. Bian, S. B. Zieba, W. Morris, X. Han, D. C. Richter, K. A. Brown, C. A. Mirkin and A. B. Braunschweig, Chem. Sci., 2014, 5, 2023-2030; C. E. Hoyle and C. N. Bowman, Angew. Chem., Int. Ed., 2010, 49, 1540-1573; C. E. Hoyle, A. B. Lowe and C. N. Bowman, Chem. Soc. Rev., 2010, 39, 1355-1387). In this process, polymer height can be controlled by varying the illumination time at any feature. This process also involves depositing methacrylate or acrylate monomers and the photoinitiator 2,2-dimethoxy-2-phenylacetophenone (DMPA) from the tip arrays onto a thiol-terminated glass slide by encapsulation within a polyethylene glycol (PEG) matrix, which facilitates transfer of the ink via the aqueous meniscus that forms between the tips and the surfaces. In this approach, light was transmitted onto the surface through the apertures in a 15,000-tip beam pen array to initiate the polymerization, where chains as long as 1 μm in length were grown. The drawback of this and other previous approaches for making brush polymer arrays, however, is that they cannot create patterns containing different polymers in close proximity. Alternatively, scanning probe methods that are capable of printing multiple inks with micrometer registration do exist, but these cannot control feature height at each position independently.

Thus, new strategies are still needed to create a viable 4D patterning platform based on massively parallel SPL that combine, simultaneously, the ability to localize energy to sub-1 micrometer areas, print over large areas, and introduce different inks to the surface.

### SUMMARY

In accordance with at least one exemplary embodiment, a flow-through photochemical microfluidic reactor is disclosed. The microfluidic reactor may include a polymer pen array, translatable along first, second, and third axes, a light source for illuminating the polymer pen array, a reactive surface disposed opposite the polymer pen array, and a flow-through microfluidic cell having a reactive chamber. The polymer pen array can include a plurality of pyramidal tips formed from an elastomeric polymer or mixture of polymers. The tips may further be BPL or PPL tips. The reactive chamber may be disposed between the polymer pen array and the reactive surface, and may have a first opening adapted to receive the polymer pen array therethrough, and a second opening adjacent the reactive surface. The first axis and the second axis may be parallel to the plane of the reactive surface, and the third axis may be perpendicular to the plane of the reactive surface. The polymer pen array can be mounted on a support, the support being adapted to seal the first opening of the reactive chamber when the polymer pen array is received within the reactive chamber. Further, the reactive chamber may be in fluid communication with an influx conduit and an outflux conduit, with the influx conduit being adapted for introducing an inbound solution into the reactive chamber, and the outflux conduit being adapted for withdrawing an outbound solution from the reactive chamber.

In accordance with another exemplary embodiment, a method for 4-dimensional printing is disclosed. The method can include receiving a polymer pen array within a reactive chamber of a microfluidic cell, the polymer pen array including a plurality of pen tips, introducing a first solution into the reactive chamber, contacting the pen tips with a reactive surface at a first position in the presence of the first solution, and illuminating the polymer pen array with a light source. The method can further include contacting the pen tips with the reactive surface at a second position in the presence of the first solution, and reilluminating the polymer pen array with the light source. The method can further include withdrawing the first solution from the reactive chamber, introducing a second solution into the reactive chamber, contacting the pen tips with the reactive surface at the first position or the second position in the presence of the second solution and reilluminating the polymer pen array with the light source.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary embodiment of a massively parallel flow-through photochemical microfluidic reactor.

FIG. 2a also shows an exemplary embodiment of a massively parallel flow-through photochemical microfluidic reactor.

FIG. 2b shows a detail of the reaction chamber of an exemplary embodiment of a massively parallel flow-through photochemical microfluidic reactor.

FIGS. 3a-3b are schematics showing parameters that may be controlled by an exemplary embodiment of a massively parallel flow-through photochemical microfluidic reactor.

FIG. 4 shows a detail of a pyramidal pen tip of an exemplary embodiment of a massively parallel flow-through photochemical microfluidic reactor.

FIG. 5 shows a light focus channel in contact with a reactive surface in the liquid phase beneath the pyramidal tips of an exemplary embodiment of a massively parallel flow-through photochemical microfluidic reactor.

FIG. 6 shows an exemplary method for 4-dimensional printing utilizing an exemplary embodiment of a massively parallel flow-through photochemical microfluidic reactor.

FIG. 7 is a diagram of an exemplary embodiment of a microfluidic cell according to the present disclosure.

FIG. 8 shows an exemplary wafer mold for a microfluidic cell.

FIG. 9 shows exemplary embodiments of microfluidic cells, filled with fluids of diverse colors.

FIG. 10 shows an exemplary method of microfluidic cell preparation.

FIG. 11 is a fluorescence microscopy image of brush polymer patterns of rhodamine printed within a microfluidic cell.

FIG. 12 shows the normalized fluorescence of the spots in FIG. 11.

FIG. 13 shows the relationship between t and the normalized fluorescence of FIG. 12.

FIG. 14 shows the relationship between z-piezo extension, diameter (black circles) and normalized fluorescence (grey circles).

FIG. 15 shows the relationship between the ratio of photoinitiator to monomer (DMPA/rhodamine) and the normalized fluorescence.

FIG. 16 shows changes of fluorescence intensity with t of each spot within an array, where a 2×2 brush polymer pattern of rhodamine is printed by each pyramidal tip using a static printing protocol.

FIG. 17 shows changes of fluorescence intensity with t of each spot within an array, where a 2×2 brush polymer pattern of rhodamine is printed by each pyramidal tip using a dynamic printing protocol.

FIG. 18 is a fluorescence microscopy image, taken with a 530-620 nm longpass filter, of multi-color brush polymer pattern of fluorescein and coumarin, printed on a thiol-terminated glass slide using a dynamic printing protocol.

FIG. 19 is a fluorescence microscopy image of the multi-color brush polymer pattern of FIG. 18, taken with a 400-600 nm longpass filter.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Exemplary embodiments disclosed herein teach that 4D patterning may be achieved by embedding massively parallel tip-arrays within a flow-through microfluidic cell to locally initiate thiol-acrylate brush polymerizations. In contrast to prior art patterns created by combining massively parallel SPL with brush polymer chemistry, the reactions according to the embodiments disclosed herein may be carried out in solution, thereby allowing new reagents to be introduced while maintaining the precise feature-to-feature registration enabled by piezoelectric control over the position of the tip-array with respect to the surface. In addition, because reactions according to the embodiments disclosed herein may be carried out in solution, the conventional strategies of reaction optimization—commonly applied to new organic and polymer methodologies can be followed to control precisely pattern properties. Building upon the recently demonstrated beam pen lithography (S. Bian, S. B. Zieba, W. Morris, X. Han, D. C. Richter, K. A. Brown, C. A. Mirkin and A. B. Braunschweig, Chem. Sci., 2014, 5, 2023-2030) and individual tip-addressability technologies (X. Liao, K. A. Brown, A. L. Schmucker, G. Liu, S. He, W. Shim and C. A. Mirkin, Nat. Commun., 2013, 4, 2103), the embodiments disclosed herein may be used to make patterns where the chemical composition and height at each position across cm² areas can be uniquely controlled. The printed surfaces produced by the embodiments disclosed herein, by way of combination of massively-parallel SPL microfluidics with polymer chemistry to create combinatorial arrays—may provide new opportunities in optics, electronics, materials, diagnostic and detection platforms, and health research.

The embodiments disclosed herein show that brush polymers, with control over monomer composition and degree of polymerization (D_{P}) at each position, may be patterned by combining massively parallel SPL, photochemical surface-initiated photochemical radical polymerizations, and a flow-through microfluidic reaction chamber. The embodiments disclosed herein also address the optimization of the grafted-from photopolymerization within the microfluidic chamber, which can provide the ability to control height, feature size, and chemical composition of each feature in the array. Exemplary embodiments disclosed herein may include a massively parallel scanning-probe photochemical microfluidic reactor, a method of optimization of chemical reactions, including brush polymerizations within the reactor, and a method of preparation of 4D fluorescent brush polymer patterns.

The embodiments disclosed herein may utilize a polymer pen lithography method such as polymer pen lithography (PPL) and beam pen lithography (BPL). For a description of polymer pen lithography, see International Patent Publication No. WO 2009/132321, and for a description of beam pen lithography, see International Patent Application No. PCT/US2010/024633, the entire disclosures of which are incorporated herein by reference.

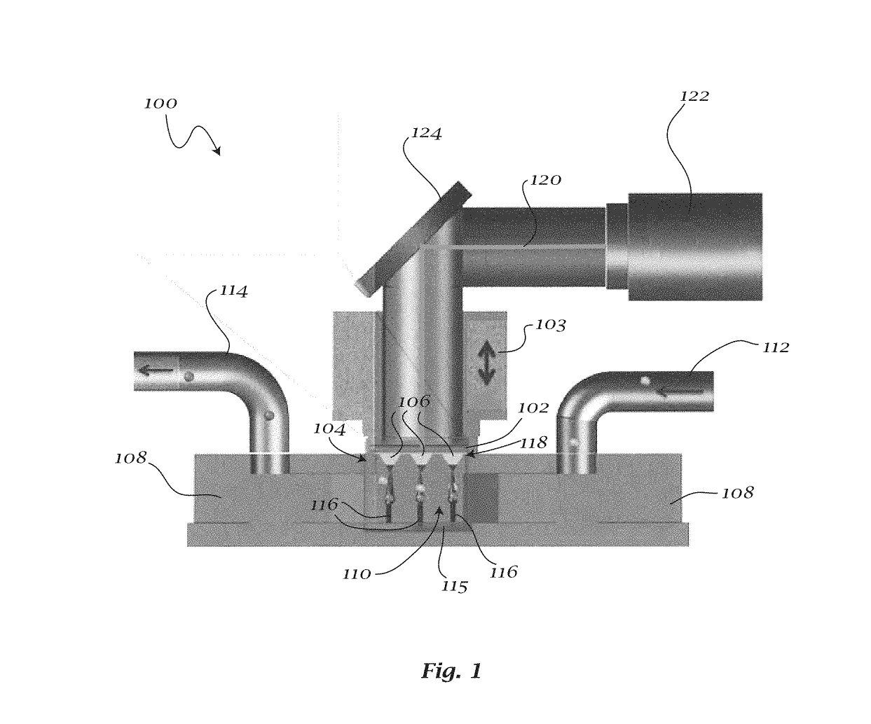

According to one exemplary embodiment, and referring to FIG. 1, a massively parallel flow-through photochemical microfluidic reactor 100 is disclosed. The flow-through reactor may include a support 102 to which a pen array 104 is adhered or otherwise coupled. The support may be formed from glass, or any other suitable material, which can include stiff, transparent polymers such as methyl methacrylate or hard polydimethylsiloxane (PDMS). The pen array 104 may include a plurality of polymer pen tips 106, which may be polymer pen lithography pen tips or beam pen lithography pen tips, as desired. As used herein, the terms “polymer pen tip”, “pen tip array”, “pen array”, or “polymer pen array” shall be construed as encompassing both PPL and BPL, unless PPL or BPL is specifically referred to. In some exemplary embodiments, the pen array 104 may have dimensions of approximately 1 cm×1 cm, and may include approximately 15,000 pen tips 106, with a tip-to-tip spacing of approximately 80 μm. Such arrays may be fabricated according to known literature protocols (F. Huo, Z. Zheng, G. Zheng, L. R. Giam, H. Zhang and C. A. Mirkin, Science, 2008, 321, 1658-1660; D. J. Eichelsdoerfer, X. Liao, M. D. Cabezas, W. Morris, B. Radha, K. A. Brown, L. R. Giam, A. B. Braunschweig and C. A. Mirkin, Nat. Protocols, 2013, 8, 2548-2560), but also including an added polyfluoroalkane coating that can prevent adhesion of inks. It should be appreciated that in various embodiments, the tip arrays can include any desired number of pen tips, for example in the range from 1000 pen tips to 10⁷ pen tips. Tip-to-tip spacing can range from 20 μm to 500 μm. The pen tips can be PPL pen tips, which can be transparent elastomeric pyramids, or BPL pen tips, wherein the elastomeric pyramids can be coated with a layer of gold with an aperture at the tip that allows for the passage of light. The elastomers from which the pen tips are formed may include PDMS or other suitable polymers, including methyl methacrylate, butyl methacrylate, as well as other elastomeric formulations or mixtures of polymers that allow reactor 100 to function as described herein. It is also contemplated that the pen tips may shaped as spheroids, hemispheroids, toroids, polyhedrons, cones, cylinders, and pyramids (trigonal or square). Apertures may also be provided in lieu of tips in the array. The above examples of tip arrays, tip numbers, tip-to-tip spacing, tip materials, tip shapes, and so forth should be construed as exemplary and not limiting. For further descriptions and examples of polymer tip arrays and their characteristics, see U.S. Pat. No. 8,745,761, the entire disclosure of which is incorporated herein by reference.

The support 102 may be coupled to an atomic force microscope (“AFM”), and may also be coupled to a z-piezo actuator 103, which may include a z-scanner and probe. The set of piezoelectric actuators typically provided with the AFM may be utilized to control the position of pen array 104 in the x and y dimensions, while the z-piezo actuator may be utilized to control the position of pen array 104 in the z dimension. Reactor 100 may also include lithography software for defining patterns and directing movement of the piezoactuators, and a microscope equipped with a digital camera.

A microfluidic cell 108 having a flow-through chamber 110, an influx conduit 112 and an outflux conduit 114 may be disposed below pen array 104 and on top of a substrate 115 that can include a reactive surface 116, for example, a glass slide including reactive organic functional groups, such as, for example, terminal thiol residues, (i.e. a thiol-terminated glass surface). In other exemplary embodiments, the reactive surface 116 may include reactive organic functional groups such as alkynes, alkenes, azides, halides, acids, alcohols, active esters, aldehydes, acrylates, methacrylates, dienes, phosphines, vinyls, styrenes, norbornenes, amines, epoxides, or any other organic reactive functional groups that are able to interact with the chosen photochemically activated molecules in solution in chamber 110, so as that allow reactor 100 to function as described herein.

The flow-through microfluidic chamber 110 is where reagents, for example monomers and photoinitiators, may be mixed in solution with the reactive surface 116, in the presence of the array 104 of pen tips 106 that localize light onto the surface. The tip array 104 is brought into proximity with the reactive surface 116 by inserting array 104 into the upper opening 118 of chamber 110 of microfluidic cell 108. The contact between the support 102 that holds array 104 and the microfluidic cell 108 can form a seal in the reactive chamber 110. In addition, tip array 104 can be moved substantially freely across reactive surface 116 because the dimensions of opening 118 of chamber 110 may be greater than the dimensions of tip array 104. For example, in some embodiments, the dimensions of upper opening 118 may be approximately 1.5 cm×1.5 cm, while the dimensions of tip array 104 may be approximately 1.0 cm×1.0 cm. Diverse dimensions for the upper opening as well as for the tip array have also been contemplated. For example, in various embodiments, the dimensions for the upper opening can be in the range from 100×100 μm to 8 cm×8 cm, and the dimensions of the pen array can be in the range from 50×50 μm to 8 cm×8 cm. Other opening and array dimensions, for example those having unequal sides, may also be contemplated and provided as desired. Ultraviolet or visible light 120 may be directed towards pen array 104 from a light source 122, which may be an LED or any other suitable light source, via a mirror 124, if desired.

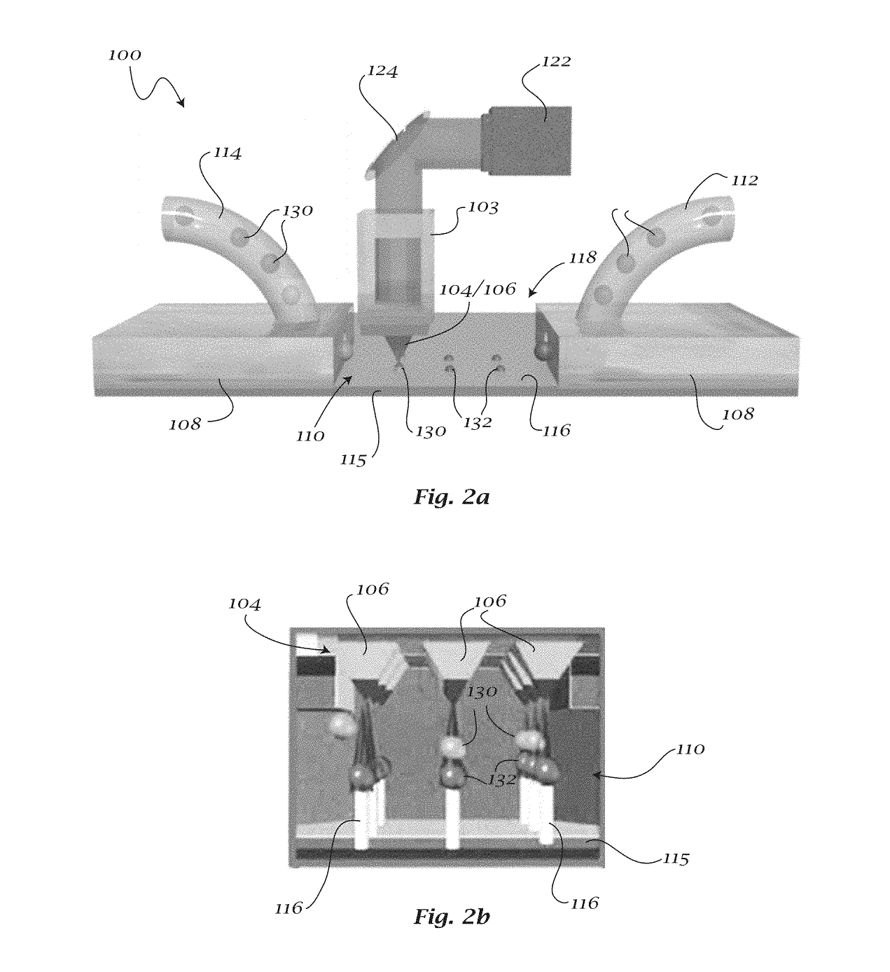

Referring now to FIGS. 2a-2b, printing of polymer arrays may be performed by microfluidic reactor 100. The reactor 100 may utilize pen tips 106 to direct light into desired locations in chamber 110, so as to initiate in situ reactions between the reactive surface 116 and one or more compounds that may be introduced into the microfluidic cell. In some embodiments, such compounds may be, for example, photoinitiators and monomers, for example acrylate monomers, vinyl monomers, methacrylate monomers, or any other monomer that undergoes radical photopolymerization, or any molecule containing photochemically reactive groups, for example alkenes, thiols, nitrobenzenes, and so forth. The molecules can possess a variety of functional materials of biological origin, for example: carbohydrates, peptides, nucleotides; fluorescent dyes, including fluorescein, rhodamine, coumarin; nanomaterials, including nanoparticles, nanorods, and quantum dots; electronically active materials, such as polycyclic aromatic hydrocarbons, and molecular switches; materials for separations, such as metal organic frameworks; and electronic materials, such as metal ion, organic and inorganic semiconductors. Photoinitiators can include 2,2-dimethoxy-2-phenylacetophenone, benzoyl peroxide, azobisisobutyronitrile, and many other common molecules used to initiate photochemical reactions.

In one exemplary embodiment, a first compound 130 may be coupled to reactive surface 116 by a photochemical polymerization reaction initiated by irradiation by ultraviolet light. The first compound 130 may be provided in a first reactive solution, which may be introduced to microfluidic chamber 110 of cell 108 via influx conduit 112. After first compound 130 is polymerized to the surface containing terminal thiol residues 116 at desired locations, a second compound 132 may be provided in a second solution that can also be introduced via influx conduit 112, replacing the solution containing first compound 130, which is flushed out of chamber 110 through outflux conduit 114. The photochemical polymerization reaction may then be repeated, and other compounds may be introduced into chamber 110, as desired. Importantly, the reactive solutions can be changed between each photochemical polymerization, so the composition of inks and D_{P} at different points in the pattern can be varied, thereby enabling 4D printing. As shown in FIG. 2, first compound 130, second compound 132, and any additional compounds may be polymerized at diverse locations, or, as shown in FIG. 2b, first compound 130, second compound 132, and any additional compounds may be polymerized at the same locations.

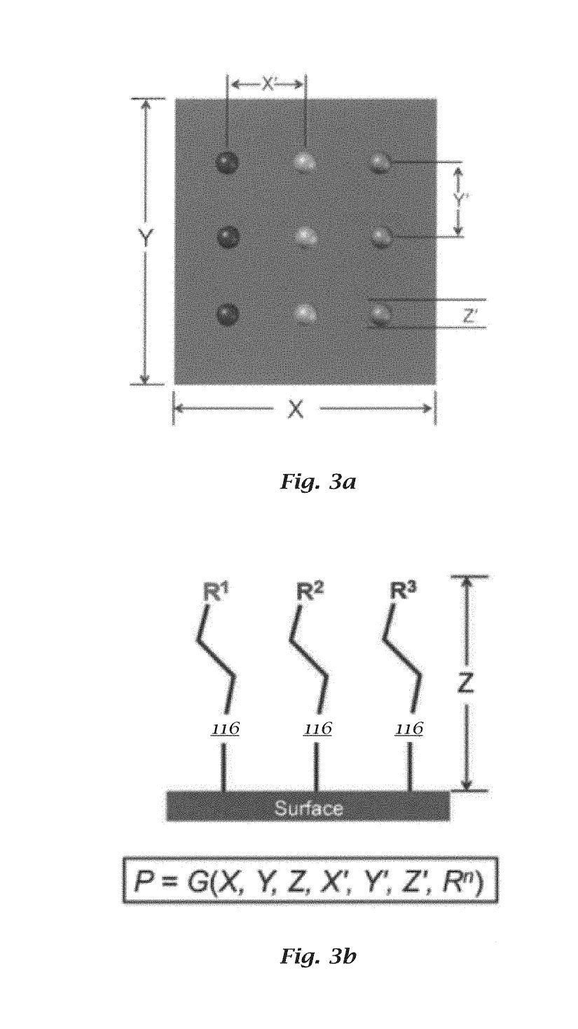

In some exemplary embodiments, microfluidic reactor 100 may allow a user to control a plurality of parameters of the printed features. Such parameters may include the feature diameter, position and shape, as well as the distances between the printed features. As shown in FIGS. 3a-3b, up to seven parameters may be controlled, and presented in [P=G(X, Y, Z, X′, Y′, Z′, Rⁿ)], where X and Y may represent the position of the feature relative to the surface along the x and y axes, respectively; X′ and Y′ may represent the relative distance between any two adjacent features along the x and y axes, respectively; Z may represent the height of each feature; Z′ may represent the diameter of each feature, and Rⁿ may represent the chemical composition of each feature. An AFM may be utilized to position the pen tips along the x and y axes, while a z-piezo actuator may be utilized to position the pen tips along the z axis.

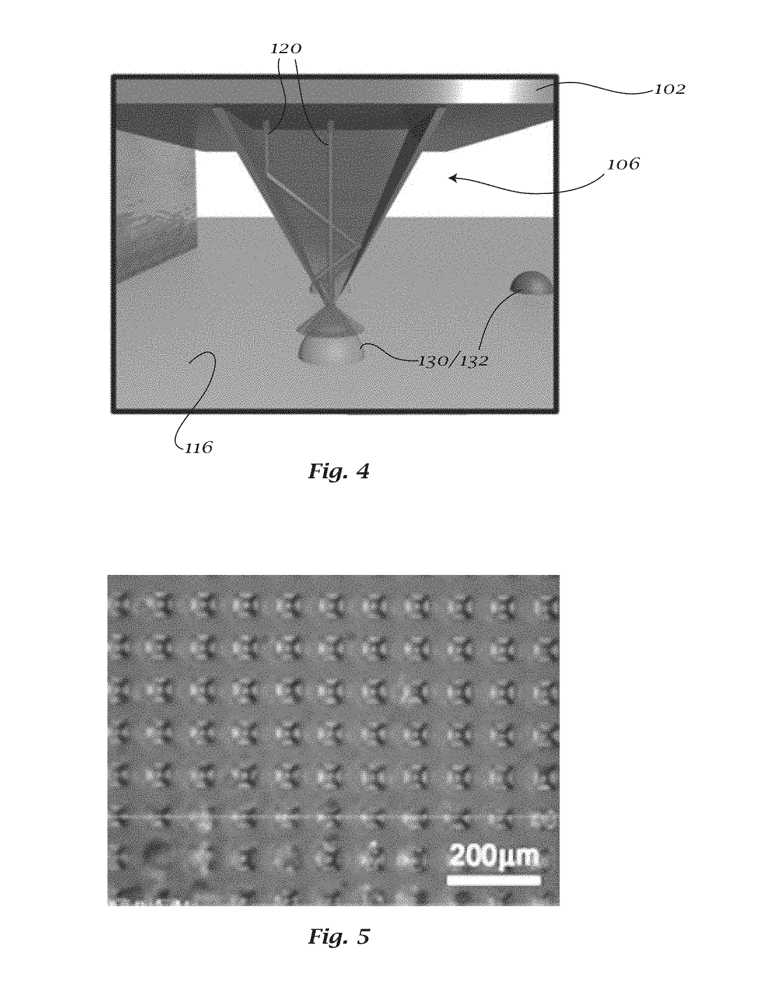

Turning to FIG. 4, light 120 that is reflected onto the back of the array can focused when passing through pen tips 106, so that the higher photon flux at the apex of the pen tips localizes the reactions to areas where tips 106 are in contact with surface 116. Consequently, polymerization proceeds faster beneath pen tips 106 than on other areas on surface 116. The PDMS elastomer from which tips 106 are formed may be sufficiently pliable such that the tips can be pressed into surface 116 so as to vary feature diameter by changing the contact area. The feature diameter can therefore be determined by the contact area between a pen tip 106 and the surface 116, allowing sub-micrometer feature dimensions to be achieved.

Polymerization occurs upon irradiating the back of the tip array with ultraviolet or visible light. It should be appreciated that, in various embodiments, the wavelength of the light used for irradiation can be varied to include visible wavelengths that match the absorption of the selected photoinitiator, which can result in the generation of radicals by splitting the photoinitiator and, in turn, can initiate a polymerization reaction between monomers in the chamber 110 and the reactive components of the reactive surface 116. For example, in some embodiments, 365 nm light may be used to initiate a thiol-acrylate polymerization between monomers in the chamber and the thiols emanating from the glass surface.

It should be appreciated that, unlike typical beam pen arrays, the tip arrays disclosed herein that are used to focus the light in the fluid phase may not require a metal film and an aperture at the apex to focus light. Rather, the light-focusing ability of the pyramidal pen tip nanostructures is sufficient to increase the rate of the polymerization reaction directly beneath the pyramidal tips in the microfluidic chamber 110, as shown in FIG. 5. It should also be noted that the use of BPL arrays rather than PPL arrays to focus the light may limit polymerizations substantially to areas beneath the apices of the tips. While the methods for polymer printing disclosed herein are substantially the same when used with PPL arrays and BPL arrays, it should be noted that when PPL arrays are used, feature diameter may vary with z-height, while when BPL arrays are used, there is no relationship between z-height and feature diameter.

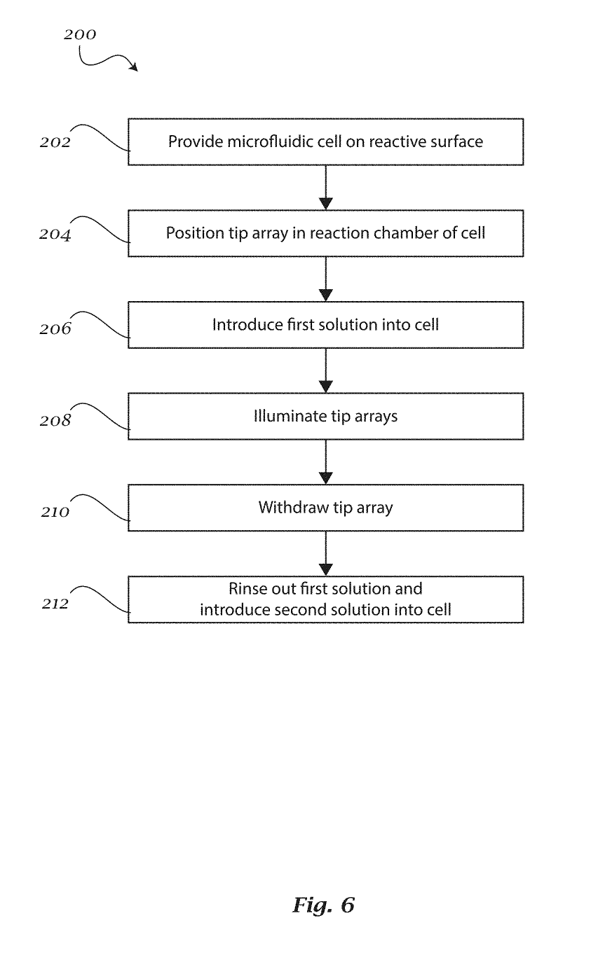

FIG. 6 shows an exemplary embodiment of a method 200 for 4-dimensional molecular printing within a massively parallel flow-through chemical reactor. At step 202, a microfluidic cell may be provided on a reactive surface. At step 204, a tip array may be lowered into the microfluidic cell, thereby sealing the opening of the microfluidic cell reaction chamber. The tip array may be positioned in the reaction chamber of the cell at a desired location where a feature is to be printed. At step 206, a first solution containing desired reagents may be introduced into the cell reaction chamber, for example, via an influx conduit. At step 208, the backs of the tip arrays may be illuminated so as to channel light to the reactive surface, thereby initiating polymerization. Subsequently, at step 210, the tip array may be withdrawn from the reactive surface.

At step 212, the solution containing the reagents may be rinsed out of the cell, for example via an oufflux conduit, and a second solution may be introduced into the cell. The second solution may include the same reagents, photoinitiators, and/or solvent as the first solution or may include different reagents, photoinitiators, and/or solvent from the first solution. Steps 204 and 208-210 may then be repeated, with the tip array being moved to another location on the reactive surface, or maintained at the previous location on the reactive surface. Alternatively, step 212 may be skipped, and steps 204 and 208-210 (in the case of static printing) or steps 204-210 (in the case of dynamic printing) may be repeated using the first solution, with the tip array being moved to another location on the reactive surface, or maintained at the previous location on the reactive surface. Accordingly, steps 204 and 208-212 and/or steps 204 and 208-210 and/or steps 204-210 may be repeated as necessary to achieve a desired pattern. Thus, multi-spot patterns, where each pen tip produces multiple features, may be created by subsequently lifting the tip arrays, moving them to a new location, and repeating method 200. Patterns also may be created where the multiple spots created by a single tip were composed either of the same ink or of different inks.

FIG. 7 shows an exemplary microfluidic cell 108 for use with microfluidic reactor 100. In some embodiments, the body 140 of microfluidic cell 108 may be formed, for example, from PDMS or other materials commonly used to make microfluidic components, such as, for example, silicon/glass, elastomers, thermosets, hydrogels, and thermoplastics. Body 140 may be shaped as a generally rectangular prism having a length, a width and a height, although diverse shapes may be contemplated and provided as desired. Microfluidic cell 108 may include reaction chamber 110, which may be a void defined in body 140, and may extend from the upper surface 146 to the bottom surface 148 of the body. Reaction chamber 110 may be in fluid communication with an influx microfluidic channel 142 and an outflux microfluidic channel 144. The influx and outflux microfluidic channels may each, respectively, be in fluid communication with influx conduit 112 and outflux conduit 114 by way of apertures 150 in a surface of the microfluidic cell, for example upper surface 146. In some exemplary embodiments, cell 108 may have a length of approximately 75 mm, a width of 25 mm, and a height of 1 mm; chamber 110 may have a length and width of 15 mm, and a height of 1 mm; and the microfluidic channels 142, 144 may have a diameter of 500 μm. However, it should be appreciated that diverse dimensions for the microfluidic cell and its components may be contemplated and provided as desired. The microfluidic cell can further contain multiple inlets and mixing chambers, valves, and chaotic mixers. The size of the microfluidic cell can be in the range from the size of its reaction chamber, to, for example, 13×13 cm, or any other suitable size.

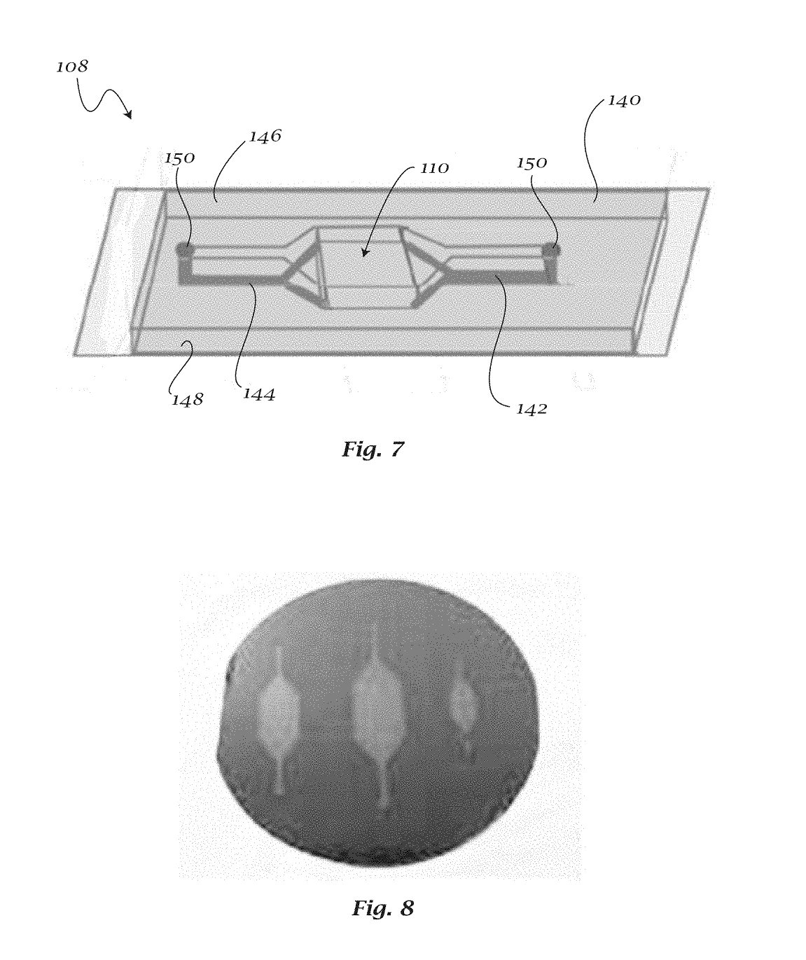

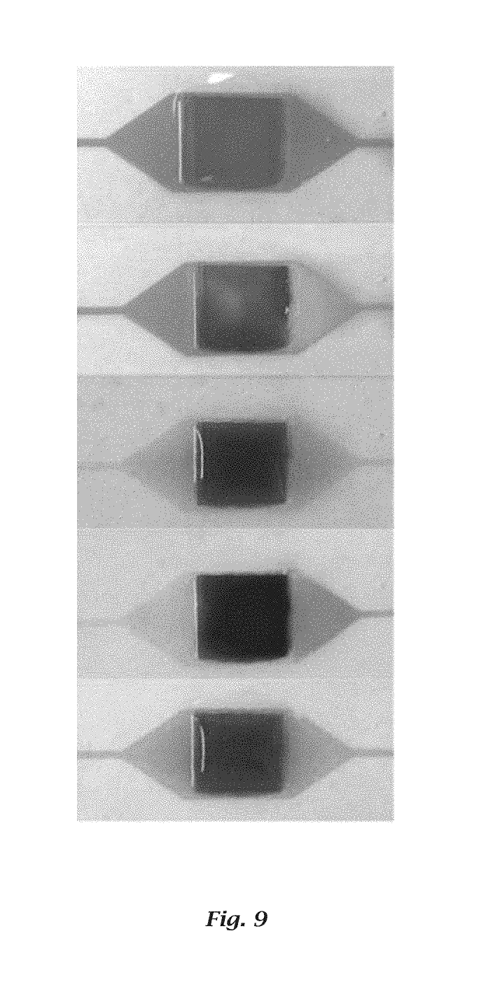

Microfluidic cells 108 for use with microfluidic reactor 100 may be manufactured via different methods. According to one exemplary method of microfluidic cell preparation, a wafer mold for the microfluidic cell, as shown in FIG. 8, may be prepared by conventional Si-photolithography methods (F. Huo, Z. Zheng, G. Zheng, L. R. Giam, H. Zhang and C. A. Mirkin, Science, 2008, 321, 1658-1660). Subsequently, to create the cell, the patterned wafer molds may be placed in a glass petri dish and exposes to O₂ plasma (for example, Harrick PDC-001) for 2 minutes at high power to grow a thin oxide layer. The wafer may then be placed on a side of a 12-inch diameter vacuum desiccator. 100 μL heptadecafluoro-1,1,2,2-tetra(hydrodecyl)trichlorosilane may then be added to 4 mL PhMe and placed on an opposite side of the 12-inch diameter vacuum desiccator. Vacuum may then be applied until the PhMe solution starts boiling, and static vacuum may be maintained for 24 hours. 17 g of h-PDMS precursor and 5.0 g of (25-35% (wt/wt) methylhydrosiloxane)-dimethylsiloxane copolymer may be weighed in a weighting boat and the mixture may be vigorously stirred for 5 min using a plastic spatula. The weighing boat containing the prepolymer mixture may then be put into a desiccator connected to a vacuum line. The desiccator may be kept under vacuum for 15 min so as to remove trapped air bubbles. The copolymer may then be poured on the prepared wafer, such that the wafer becomes covered by the copolymer. The master wafer may then be placed in a sealed container overnight at room temperature. After the copolymer is fully cured, the PDMS film may be removed from the master, and the fluid cell may be placed onto a clean microscope slide for storage. It should be appreciated that, for manufacturing the microfluidic cell, one skilled in the art may vary the procedures and materials disclosed herein as desired, without departing from the spirit of the disclosure. FIG. 9 shows exemplary microfluidic cells, filled with fluids of diverse colors.

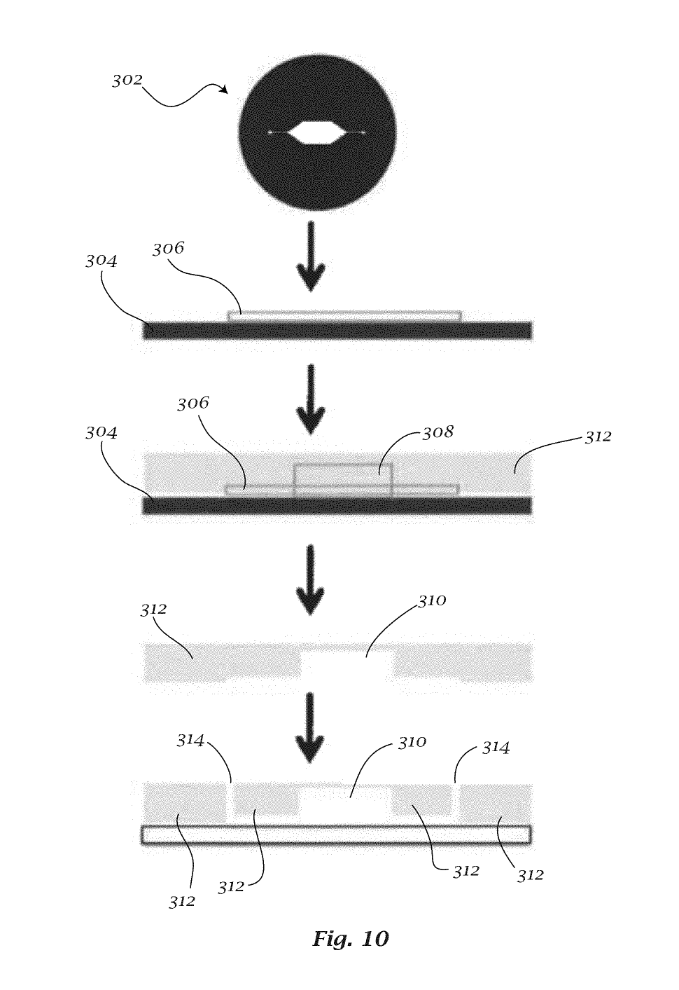

According to another exemplary method of microfluidic cell preparation, as shown in FIG. 10, a photomask 302 of the microfluidic cell, may be designed, for example using computer-aided design software, and then fabricated. The photomask image may then be projected onto a silicon wafer 304, which may be formed from, for example, NOVA electric material, STK8414, using a photolithography technique. A photoresist 306 (for example, SU8-100) may be spin-coated and baked to achieve a final thickness of 100 μm. This photoresist-patterned wafer may serve as a mold. A piece of 1 cm×1 cm glass 308 may then be adhered to the center of the pattern to define the void 310 of the reaction chamber. 2 g of PMDS may be poured onto the master and baked at 65° C. for approximately 2 hours. After cooling to room temperature, the PDMS slab 312 may be carefully peeled off and apertures 314 of a desired dimension may be created. It should be appreciated that, for manufacturing the microfluidic cell, one skilled in the art may vary the procedures and materials disclosed herein as desired, without departing from the spirit of the disclosure.

Additional aspects and details of the disclosure will be apparent from the following examples, which are intended to be illustrative rather than limiting.

### EXAMPLES

### Example 1

### Single Spot, Single Color Printing within Photochemical Reactor

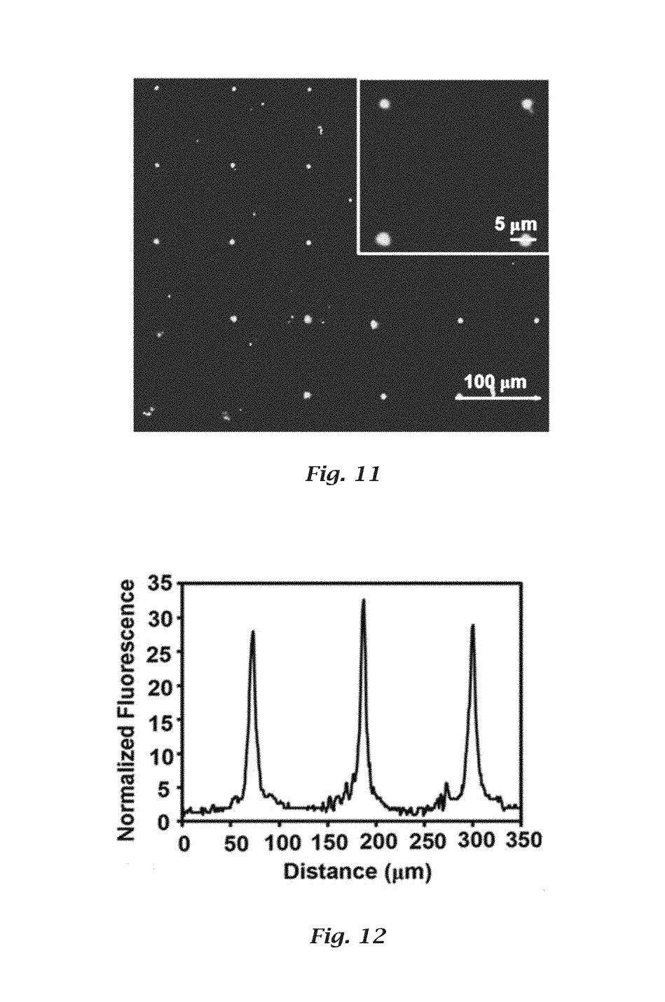

To achieve 4D micropatterning, it was first necessary to optimize the thiol-acrylate reaction within the massively parallel photochemical reactor because the microfluidic cell is an entirely different reactive environment than the PEG matrix that previously encapsulated the monomers during polymerization in the prior art (S. Bian, S. B. Zieba, W. Morris, X. Han, D. C. Richter, K. A. Brown, C. A. Mirkin and A. B. Braunschweig, Chem. Sci., 2014, 5, 2023-2030), Here, a single spot of polymers of rhodamine was printed with each pyramid (FIG. 11), and the normalized fluorescence was measured by fluorescence microscopy (Zeiss Axiovert 200, λₑₓ=562 nm, λₑₓ=624 nm) (FIG. 12). The aim was to understand how polymerization conditions affect polymer height, but the D_{P} of brush polymers in nanoarrays is notoriously difficult to determine. Thus instead of optimizing for absolute D_{P}, optimization was done by attempting to maximize normalized fluorescence, which reflected the difference in D_{P} between areas directly below the pens, where light intensity is highest, and the rest of the surface. Previously, it was shown that the normalized fluorescence of rhodamine (Equation 1) is a useful parameter for studying surface reactivity because it correlates well to the polymer chain length and is relatively independent of microscope settings. Importantly, when the fluorescence of the illuminated areas equals that of the non-patterned areas, the normalized fluorescence is 1.

$$Normalized fluorescence = \frac{Fluorescence counts at a feature}{Fluorescence counts of the background} . \qquad Equation 1$$

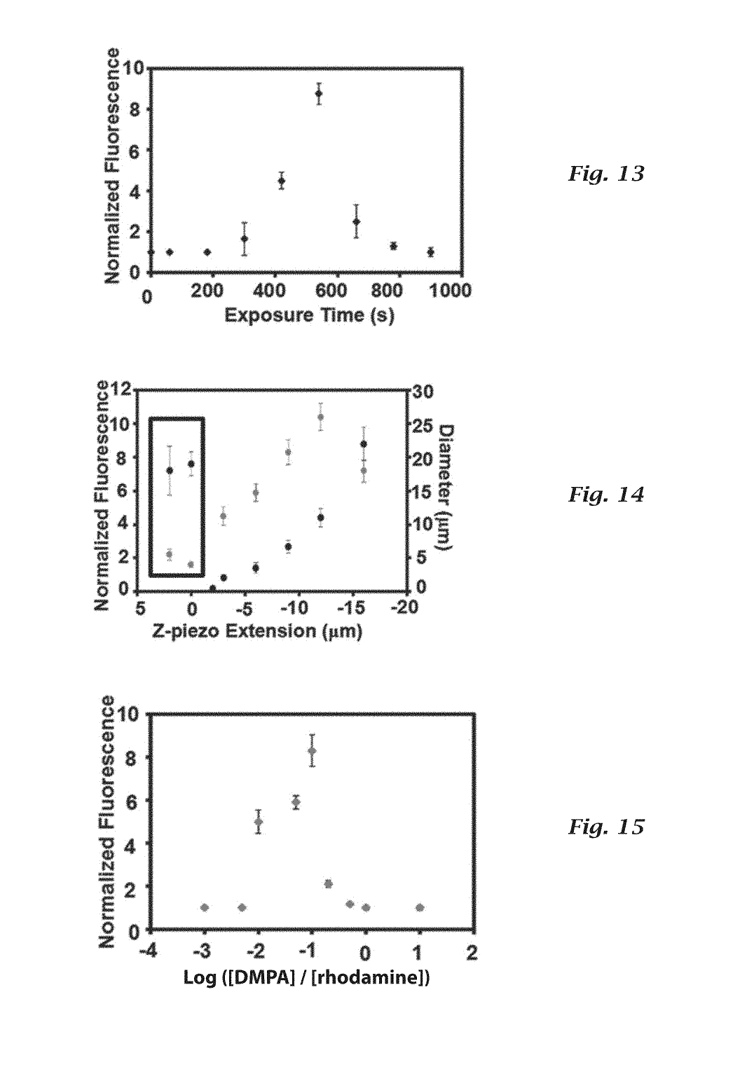

To understand the thiol-acrylate brush polymerization within the flow-through massively-parallel photoreactor, the effect exposure time, light intensity, photoinitiator-to-monomer ratio ([DMPA]/[rhodamine]), and tip height on normalized fluorescence and spot diameter were explored. It was reconfirmed that the brush polymer height in the polymer arrays prepared herein correlates directly to exposure time. The normalized fluorescence was taken as the average from 20 spots from across the pattern, and error was reported as a standard deviation from the mean. The reaction was optimized by varying exposure time (FIG. 13), t, light intensity, z-piezo extension (FIG. 14), and [DMPA]/[rhodamine] (FIG. 15). DMF was chosen as the reaction solvent because it does not swell the PDMS of the microfluidic cell, and because it is an excellent solvent for radical polymerizations.

Preparation: Massively parallel elastomeric tip arrays with ˜15000 pens and tip-to-tip spacing of 80 μm were prepared following previously reported protocols (D. J. Eichelsdoerfer, X. Liao, M. D. Cabezas, W. Morris, B. Radha, K. A. Brown, L. R. Giam, A. B. Braunschweig and C. A. Mirkin, Nat. Protocols, 2013, 8, 2548-2560). A typical printing procedure is described, although in the systematic studies, solvents, concentrations of monomers, photoinitiator concentration, z-extension, reaction time, t, and light intensity were varied. Tips were covered with a single layer of heptadecafluoro-1,1,2,2-tetra(hydrodecyl)trichlorosilane to render the pen arrays hydrophobic. Ink solutions containing DMPA (0.03 mg, 0.117 mM) and rhodamine (0.8 mg, 1.20 mM) were dissolved in 1 ml dimethylformamide (“DMF”). The microfluidic cell was placed onto a thiol-terminated glass surface. The surface was fixed onto the stage of a Park XE-150 scanning probe microscope (Park System Corp.) equipped with a PPL head and XEP custom lithography software. The elastomeric pen array was mounted onto the z-piezo of the AFM and localized on the top of microfluidic cell to seal the fluid cell. The tip array was leveled by optical methods with respect to the substrate surface using an x,y tilting stage.

Procedure: A dot array was printed by bringing the tip array into contact with the thiol-terminated glass surface, introducing the ink solution into the solution cell, and varying the light intensity, exposure time, [DMPA]/[rhodamine] ratio and z-piezo extension, with the point at which the tips first contact the surface considered z=0. Light intensity was measured after reflection off of the mirror with a light intensity detector (General UV 513AB), and each measurement was recorded with same distance between the mirror and the detector. All fluorescence images were observed under a fluorescence microscopy Zeiss Axiovert-200 and processed with Axioversion Rel. 4.8. Light sources was provided by with Rhodamine channel (λₑₓ=562 nm, λₑₘ=624 nm). Feature size was determined as the average of 20 spots, error was defined as the standard deviation from the average, and the feature edge was defined as the point at which fluorescence decreased 90% from the maximum.

Normalized fluorescence increased with t, and reached a maximum of 10±0.5 with t of 540 s (FIG. 13), and then decreased to 1.0 as t was extended. Light intensity onto the surface was varied between 4.3 and 300 mW cm⁻², and normalized fluorescence maximizes at a light intensity of 42.74 mW cm⁻², and further increasing the light intensity eventually and reduces the normalized fluorescence to 1.0. The decay of normalized fluorescence with increasing t and light intensity were most likely the result of either an increase in background fluorescence or the damage of reactive surface. Our previous research has shown that at longer reaction times (>20 min) and the highest light intensity (>90 mW cm⁻²), the surface is destroyed and no polymer is found. Although if significant offsite polymerization occurred, a normalized fluorescence below 1 would be observed. In radical polymerizations, excessive photoinitiator is an inhibitor and it was observed that normalized fluorescence dropped rapidly following a maximum at the log([DMPA]/[rhodamine]) of 0.2 (FIG. 15).

These results showed that even though light reaches all areas of the surface, reaction conditions can be carefully balanced such that the rate of polymerization directly beneath the tips can be at least 10-fold higher than at other areas of the surface. While beam pen arrays may be used to ensure that polymerizations are limited only to the areas beneath the apexes of the tips, the focus of this example, however, was to demonstrate massively parallel brush polymerizations in the fluid cell and to create multi-ink patterns. When using elastomeric pyramids to pattern surfaces, the feature diameter can be controlled by varying the z-piezo extension, which changes the contact area where the surface is directly in contact with the elastomeric pyramids that have been extended, which increases with increasing z-piezo extension. In the microfluidic cell it was found that both normalized fluorescence and spot diameter were dependent upon z-piezo extension (FIG. 14). Average feature diameters of 480±50 nm were observed when the tips were just brought into contact with the surface (z-extension=−2 μm) confirming that this method can achieve sub-1 micrometer feature diameters, and feature diameters also increased with increasing z-extension (tips pushed further into the surface). Interestingly, similar feature diameters can be obtained when the tips are held above the surface and when they are pushed 15 μm into the surface (FIG. 14, black box); the normalized fluorescence, however, is significantly higher when the tips are in contact with the surface. This observation suggests that when the tips are held above the surface, the light intensity diminishes substantially as it diffuses away from the tips, which both decreases the rate of polymerization and increases feature diameter. Although tips are being pushed into the surfaces, it was found that this does not prevent polymers as long as ˜400 nm from forming—which is consistent with previous observation—and is an observation that should be the subject of future investigation.

### Example 2

### Multi-Spot Single Color Printing within Photochemical Reactor

Using the optimized polymerization conditions that maximize the normalized fluorescence ([DMPA]/[rhodamine]=0.1 in DMF; light intensity 42.74 mW cm⁻²; 365 nm UV light, Z-extension −9 μm), methods were developed to print multiple fluorescent polymer spots with each pyramid in the tip array. Two different methods were attempted for creating 2×2 patterns with each tip by polymerizing rhodamine, with a 35 μm spot-to-spot spacing. The first, referred to as “static printing”, involved introducing the ink mixture containing rhodamine through the tubing, illuminating the surface, moving the tip array, and illuminating a different point on the surface. The second method, referred to as “dynamic printing”, involves rinsing the microfluidic cell with DMF and introducing a fresh ink mixture between each illumination. Four spots were printed with each tip at t ranging from 140-660 s, and the average normalized fluorescence was determined for each spot.

Preparation in this example was the same as those described in Example 1. Procedure: Multi-spot arrays were printed by bringing the tip array into contact with the thiol-terminated glass surface, and either keeping the same ink solution (static) or introducing a new ink solution (dynamic) into the microfluidic cell after printing each spot. The x,y moving speed between each spot, t, and z-piezo extend height were varied systematically to determine how they influenced the patterning. Light intensity was measured after reflection off of the mirror with a light intensity detector (General UV 513AB), and each measurement was recorded with the same distance between the mirror and the detector. The positions of each spot in the multi-spot arrays in was defined by coordinates in μm: spot 1 (−35, 35); spot 2 (0, 35); spot 3 (−35, 0); and spot 4 (0,0). All fluorescence images were observed under a fluorescence microscopy Zeiss Axiovert-200 and processed with Axioversion Rel. 4.8. Light source was provided with rhodamine channel (λₑₓ=562 nm, λₑₘ=624 nm).

With static printing (FIG. 14), a diminished fluorescence intensity was seen for each successive spot regardless of t, while, in dynamic printing mode, the fluorescence intensity was constant between successive spots printed with identical t (FIG. 15). The data presented in FIGS. 14-15 also provided insight into the uniformity of the polymers printed in an array: the error bars represent the variation of normalized fluorescence between features printed by different tips, and the variation between columns is the changes in the normalized fluorescence in different spots printed by the same tip. While the normalized fluorescence decreased between successively printed spots under the static protocol—which could arise because of consumption of ink or fouling of the tips—under the dynamic printing protocol, the differences between intensities of successive spots—and in turn polymer height—were negligible. This investigation of static and dynamic protocols can provide printing conditions for creating multi-spot arrays, where the fluorescence intensity of each feature can be controlled predictably and precisely.

### Example 3

### Multi-Spot Multi-Color Printing within Photochemical Reactor

The flow-through photochemical reactor was utilized to create patterns where different inks are immobilized in close proximity. A pattern composed of two spots with two different colored fluorescent acrylate polymers—by polymerizing fluorescein (λₑₘ=572 nm) and coumarin (λₑₘ=440 nm)—that are separated by 35 μm was printed using the dynamic printing protocol, where the chamber was washed and the new ink was introduced between each illumination. These two monomers were chosen because they are synthetically accessible and have sufficiently separated absorption and emission spectra, so they can be distinguished by fluorescence microscopy.

Tip preparation and procedures for printing within the microfluidic photochemical reactor were the same as those described for dynamic multi-spot printing described in Example 2. Three ink solutions were prepared for multicolor printing: 1) DMPA (0.03 mg, 0.117 mM) and fluorescein (0.46 mg, 1.20 mM) were dissolved in 1 ml DMF; and 2) DMPA (0.03 mg, 0.117 mM) and coumarin (0.25 mg, 1.20 mM) were dissolved in 1 ml DMF.

To create the pattern, first fluorescein was polymerized ([DMPA]/[fluorescein]=0.1; light intensity 42.74 mW cm⁻²; 365 nm UV light, 540 s; z extension −9 μm.), the cell was washed with DMF, the tips were moved 35 μm, and solution containing coumarin was introduced into the cell and polymerized under identical reaction conditions.

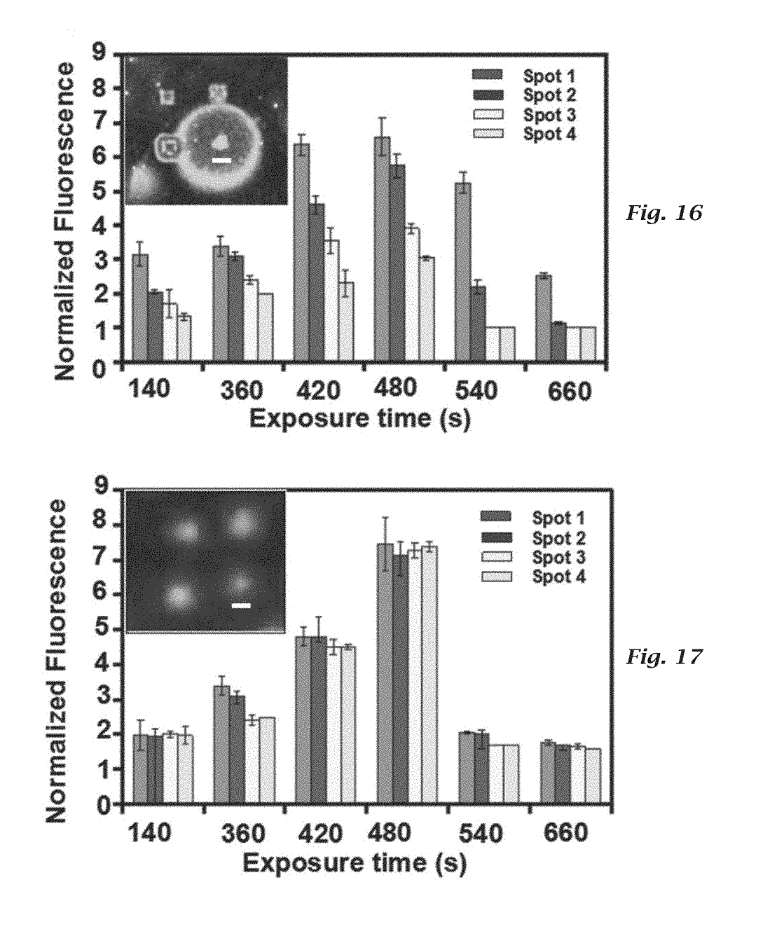

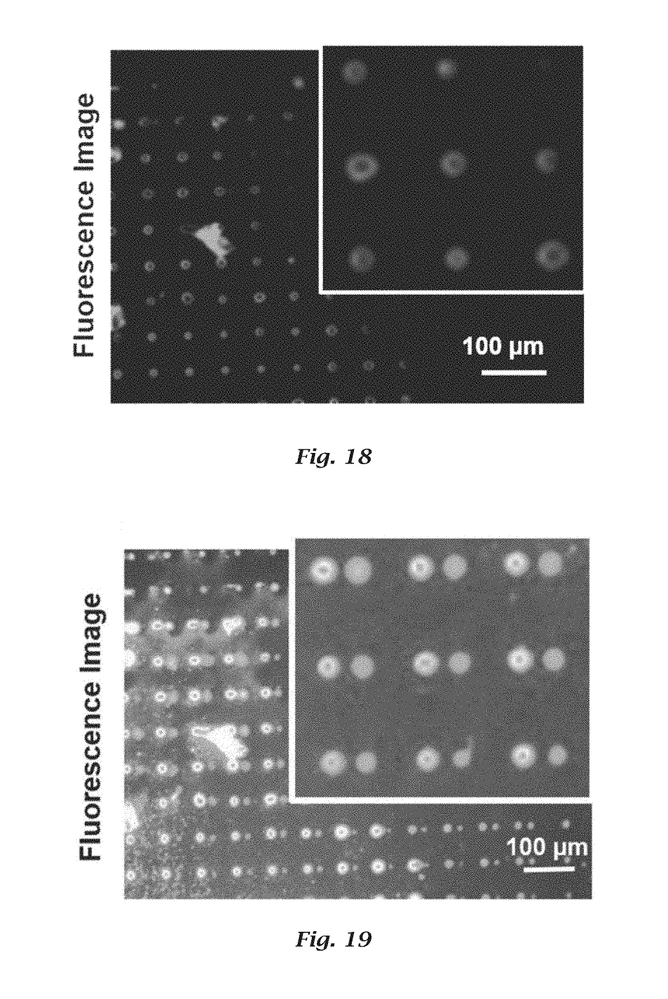

When imaging this pattern with a 600 nm longpass filter (FIG. 16) emission from the spot composed of fluorescein was observed, and when a 400 nm longpass filter is used (FIG. 17), emission from spots composed of both fluorescein and coumarin are observed, thus confirming that this flow-through photochemical printing platform can create patterns with features of different chemical compositions that are separated by only a few micrometers.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art. All of the methods disclosed and claimed herein can be made and executed without undue experimentation in light of the present disclosure.

Therefore, the above-described embodiments should be regarded as illustrative rather than restrictive. While the materials and methods of this invention have been described in terms of specific embodiments, it should be appreciated that variations to those embodiments can be made by those skilled in the art without departing from the scope of the invention as defined by the following claims. It will also be apparent to those skilled in the art that certain agents which are both chemically and physiologically related may be substituted for the agents described herein, with the same or similar results being achieved.

What is claimed is:

1. An apparatus for 4-dimensional molecular printing, comprising:
a polymer pen array, translatable along first, second, and third axes;
a light source for illuminating the polymer pen array;
a reactive surface disposed opposite the polymer pen array;
a flow-through microfluidic cell including a reactive chamber, the reactive chamber disposed between the polymer pen array and the reactive surface, the reactive chamber having a first opening adapted to receive the polymer pen array therethrough, and a second opening adjacent the reactive surface; wherein the first axis and the second axis are parallel to the plane of the reactive surface, and the third axis is perpendicular to the plane of the reactive surface.

2. The apparatus of claim 1, wherein the polymer pen array is mounted on a support, the support being larger than the first opening of the reactive chamber, such that the chamber is a sealed unit when the polymer pen array is received within the reactive chamber.

3. The apparatus of claim 1, wherein:
the reactive chamber is in fluid communication with an influx conduit and an outflux conduit;
the influx conduit is adapted for introducing an inbound solution into the reactive chamber; and
the outflux conduit is adapted for withdrawing an outbound solution from the reactive chamber.

4. The apparatus of claim 3, wherein the inbound solution includes photoinitiators and molecules that will react with the photoinitiators.

5. The apparatus of claim 1, wherein the polymer pen array includes a plurality of pyramidal tips formed from an elastomeric polymer or mixture of polymers.

6. The apparatus of claim 5, wherein the elastomeric polymer is polydimethylsiloxane.

7. The apparatus of claim 5, wherein the elastomeric tips are polymer pen lithography tips.

8. The apparatus of claim 5, wherein the elastomeric tips are beam pen lithography tips.

9. The apparatus of claim 1, wherein the reactive surface includes reactive organic functional groups.

10. A method for 4-dimensional molecular printing, comprising:
receiving a polymer pen array within a reactive chamber of a microfluidic cell, the polymer pen array including a plurality of pen tips;
introducing a first solution into the reactive chamber;
contacting the pen tips with a reactive surface, at a first position, in the presence of the first solution; and
illuminating the polymer pen array with a light source.

11. The method of claim 10, further comprising:
contacting the pen tips with the reactive surface, at a second position, in the presence of the first solution; and
reilluminating the polymer pen array with the light source.

12. The method of claim 10, further comprising withdrawing the first solution from the reactive chamber.

13. The method of claim 12, further comprising introducing a second solution into the reactive chamber.

14. The method of claim 13, further comprising:
contacting the pen tips with the reactive surface, at the first position, in the presence of the second solution; and
reilluminating the polymer pen array with the light source.

15. The method of claim 13, further comprising:
contacting the pen tips with the reactive surface, at a second position, in the presence of the second solution; and
reilluminating the polymer pen array with the light source.

16. The method of claim 10, wherein receiving a polymer pen array within a reactive chamber of a microfluidic cell further comprises sealing the reactive chamber.

17. The method of claim 10, wherein the polymer pen array includes a plurality of pyramidal tips formed from an elastomeric polymer or mixture of polymers.

18. The method of claim 17, wherein the elastomeric polymer is polydimethylsiloxane.

19. The method of claim 17, wherein the elastomeric tips are polymer pen lithography tips or beam pen lithography tips.

20. The method of claim 10, wherein the reactive surface includes reactive organic functional groups.
